(19) United States
(12) Patent Application Publication
(10) Pub. No.: US 2019/0277649 A1
(43) Pub. Date: Sep. 12, 2019

(54) MAP DISPLAY SYSTEM AND MAP DISPLAY PROGRAM

(71) Applicant: AISIN AW CO., LTD., Anjo-shi, Aichi-ken (JP)

(72) Inventor: Shinji TAKAYAMA, Okazaki (JP)

(73) Assignee: AISIN AW CO., LTD., Anjo-shi, Aichi-ken (JP)

(21) Appl. No.: 16/349,675

(22) PCT Filed: Mar. 15, 2018
(86) PCT No.: PCT/JP2018/010118

§ 371 Date: May 14, 2019

(30) Foreign Application Priority Data
Mar. 28, 2017 (JP) 2017-062378

(51) Int. Cl. G01C 21/36; G06F 3/0488; G06F 3/0485

(52) U.S. Cl. CPC G01C 21/367; G06F 3/0485; G06F 3/0488

(57) ABSTRACT

Provided is a method and apparatus for changing a display state of a map by user optimization. A map display system includes a touch position detecting part that detects a touch position on a touch device; a correspondence recording part that records correspondence between a movement of the touch position and an amount of change of a map displayed on a screen based on the movement; a map display part that changes the display of the map by the amount of change; and a correspondence revising part that revises, when a plurality of movements of the touch positions have been detected at time intervals less than or equal to a predetermined reference period, the correspondence based on the movement of the touch positions. The map display part changes a display state of the map based on the revised correspondence.

### CROSS REFERENCE TO RELATED APPLICATIONS

This Application is a National Stage of International Application No. PCT/JP2018/010118 filed Mar. 15, 2018, claiming priority based on Japanese Patent Application No. 2017-062378 filed Mar. 28, 2017.

### TECHNICAL FIELD

The aspects of the application relate to a map display system and a map display program.

### BACKGROUND ART

There is known a technique for scrolling a map based on a flick operation (see Patent Literature 1). In Patent Literature 1, the flick sensitivity for a direction going from a current location to a destination differs from the flick sensitivity for other directions. In addition, there is known a technique for scrolling a map by a distance determined based on the flick speed or the deceleration of a flick (see Patent Literature 2).

### CITATIONS LIST

### Patent Literature

Patent Literature 1: JP 2014-137300 A

Patent Literature 2: JP 2013-44760 A

### SUMMARY

### Technical Problems

However, in Patent Literatures 1 and 2, there has been a problem that even if users who perform an operation are different, the amount by which a map is scrolled based on a flick operation is fixed. That is, there has been a problem that optimal flick sensitivity greatly varies from user to user, and optimal flick sensitivity cannot be set on a user-by-user basis. Of course, it is also possible to adopt a technique for setting flick sensitivity by a user, but the setting is complicated.

Certain aspects of the application were made in view of the above-described problem, and may provide a technique in which a change in the display state of a map based on an operation performed on a touch device can be optimized on a user-by-user basis.

### Solutions to Problems

To provide the above-described technique, a map display system of the present application includes: a touch position detecting part that detects a touch position of an operating object on a touch device; a correspondence recording part that records a correspondence between movement states of the touch positions for a plurality of movements and an amount of change by which a display state of a map displayed on a screen is changed based on the movement states for the plurality of movements; a map display part that changes a display state of the map for the plurality of movements by the amount of change for the plurality of movements based on the movement states of the touch positions for the plurality of movements; and a correspondence revising part that revises, when a plurality of movements of the plurality of touch positions have been detected at time intervals, the correspondence for the plurality of movements based on the plurality of movement states of a plurality of the plurality of touch positions for the plurality of movements, the time intervals being less than or equal to a predetermined reference period, and the map display part changes a display state of the map for the plurality of movements based on the revised correspondence for the plurality of movements.

In addition, a map display program causes a computer to function as: a touch position detecting part that detects a touch position of an operating object on a touch device; a correspondence recording part that records a correspondence between movement states of the touch positions for a plurality of movements and an amount of change by which a display state of a map displayed on a screen is changed based on the movement states for the plurality of movements; a map display part that changes a display state of the map for the plurality of movements by the amount of change for the plurality of movements based on the movement states of the touch positions for the plurality of movements; and a correspondence revising part that revises, when a plurality of movements of the plurality of touch positions have been detected at time intervals, the correspondence for the plurality of movements based on the plurality of movement states of a plurality of the plurality of the touch positions for the plurality of movements, the time intervals being less than or equal to a predetermined reference period, and the map display part changes a display state of the map for the plurality of movements based on the revised correspondence for the plurality of movements.

According to those aspects configured in the above-described manner, it can be estimated, based on the movement states of touch positions for a plurality of movements, whether an operation that supplements its preceding operation has been additionally performed or whether an operation that cancels out its preceding operation has been additionally performed. When an operation that supplements its preceding operation has been additionally performed, it is highly likely that a user feels that the display state of the map has not been changed as much as intended, based on an operation performed by him/her. In this case, the correspondence between the movement state and the amount of change is revised such that the amount of change in display state based on the movement state of the touch position is revised upward. Conversely, when an operation that cancels out its preceding operation has been additionally performed, it is highly likely that the user feels that the display state of the map has been changed more than intended, based on an operation performed by him/her. Hence, the correspondence between the movement state and the amount of change is revised such that the amount of change in display state based on the movement state of the touch position is revised downward. As described above, a change in the display state of the map based on an operation performed on the touch device can be optimized on a user-by-user basis.

### BRIEF DESCRIPTION OF DRAWINGS

FIG. 1 is a block diagram of a map display system.

FIGS. 2A and 2B are diagrams showing the movement states of touch positions,

FIG. 2C is a table showing a correspondence between movement states and the display states of a map, and FIG. 2D is an illustrative diagram of the movement states of touch positions for a plurality of movements.

FIGS. 3A to 3D are illustrative diagrams of an evaluation value for flick operations, and FIGS. 3E and 3F are illustrative diagrams of an evaluation value for pinch operations.

FIGS. 4A and 4B are tables showing revised contents of the correspondence between movement states and the display states of a map.

FIG. 5 is a flowchart of a correspondence revision process.

### DESCRIPTION OF EMBODIMENTS

Here, an embodiment of the present application will be described according to the following order:

(1) Configuration of a map display system;

(2) Correspondence revision process; and

(3) Other embodiments.

(1) Configuration of a Map Display System

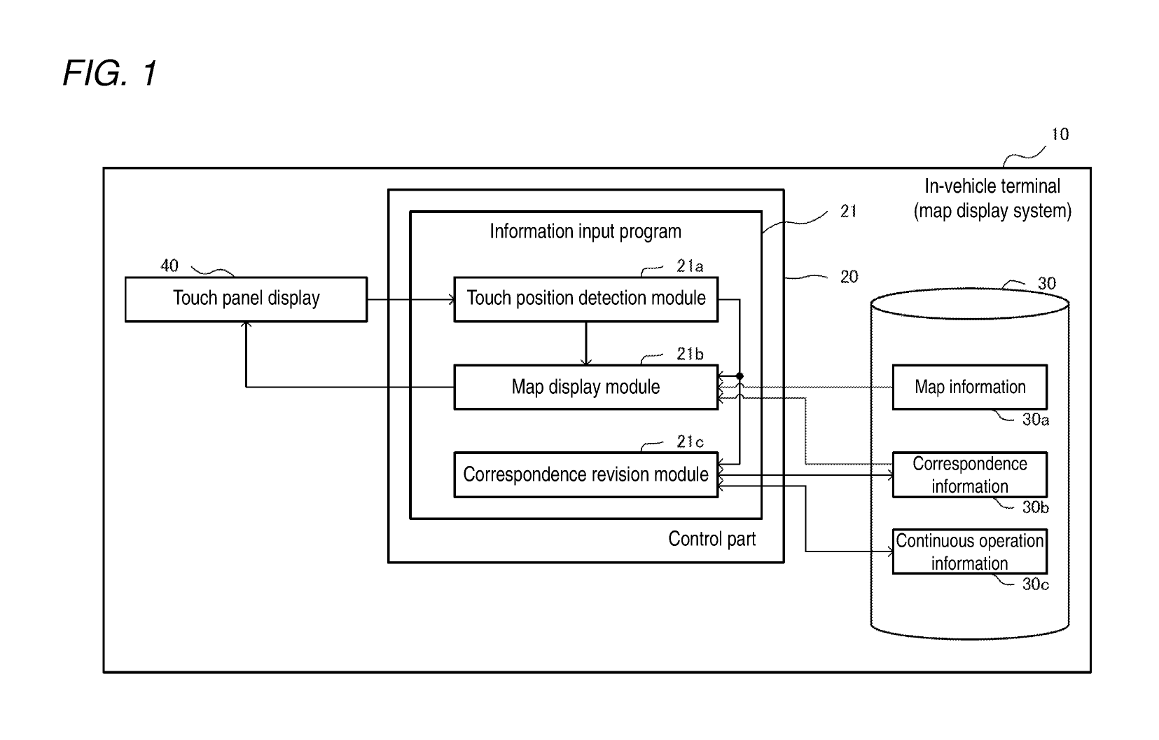

FIG. 1 is a block diagram showing an exemplary configuration of a map display system according to one embodiment. The map display system according to the present embodiment is implemented by an in-vehicle terminal 10. The in-vehicle terminal 10 is mounted on a vehicle. The in-vehicle terminal 10 includes a control part 20, a recording medium 30, and a touch panel display 40. The control part 20 includes a CPU, a RAM, a ROM, etc. The in-vehicle terminal 10 may be configured in any manner as long as it can control the touch panel display 40, and the touch panel display 40 may be provided in the vehicle. The touch panel display 40 serves as both a display that displays an image on a display surface, and a touch device that detects a touch position of an operating object on the display surface.

In the recording medium 30, there are recorded map information 30a, correspondence information 30b, and continuous operation information 30c. The map information 30a is data representing the locations and shapes of links, nodes, and ground objects such as facilities. The control part 20 renders a map based on the map information 30a. The details of the correspondence information 30b and the continuous operation information 30c will be described later.

The control part 20 executes a map display program 21 recorded in the recording medium 30. The map display program 21 includes a touch position detection module 21a, a map display module 21b, and a correspondence revision module 21c. The control part 20 that executes the touch position detection module 21a, the map display module 21b, and the correspondence revision module 21c forms a touch position detecting part, a map display part, and a correspondence revising part of this embodiment.

By a function of the touch position detection module 21a, the control part 20 detects a touch position of an operating object on the touch device. Namely, by the function of the touch position detection module 21a, the control part 20 detects a touch position of an operating object on the touch panel display 40 by obtaining an output signal from the touch panel display 40 serving as the touch device. The operating object is a user's finger.

By a function of the map display module 21b, the control part 20 changes the display state of a map displayed on a screen by the amount of change based on the movement state of a touch position. By the function of the map display module 21b, the control part 20 renders a map based on the map information 30a and outputs image data of the map to the touch panel display 40, and thereby displays the map on the touch panel display 40. The movement state of the touch position is obtained every touch period which is a period from when a finger touches the touch panel display 40 until the finger is released.

The display state of the map is the location of the map (map coordinates) and the scale of the map. By the function of the map display module 21b, the control part 20 obtains map coordinates and a scale which are the display state of a map, and renders a map based on the map coordinates and the scale. The map coordinates are, for example, real-space coordinates corresponding to a location on the map displayed at a center position of the touch panel display 40. The scale is a ratio obtained by dividing the length on the map of an object shown on the map by the length in the real space of the object. Here, of displayable maps, a map with the smallest scale is represented as a reference map. For example, the reference map may be a map with a scale of 1/10,240,000.

By the function of the map display module 21b, the control part 20 changes the location of the map (map coordinates) based on the moving speed of the touch position. By the function of the map display module 21b, the control part 20 calculates a moving speed of a touch position for a touch period from when a finger touches the touch panel display 40 until the finger is released, and changes the map coordinates based on the moving speed. Namely, the control part 20 scrolls a map displayed on the touch panel display 40, based on a flick operation.

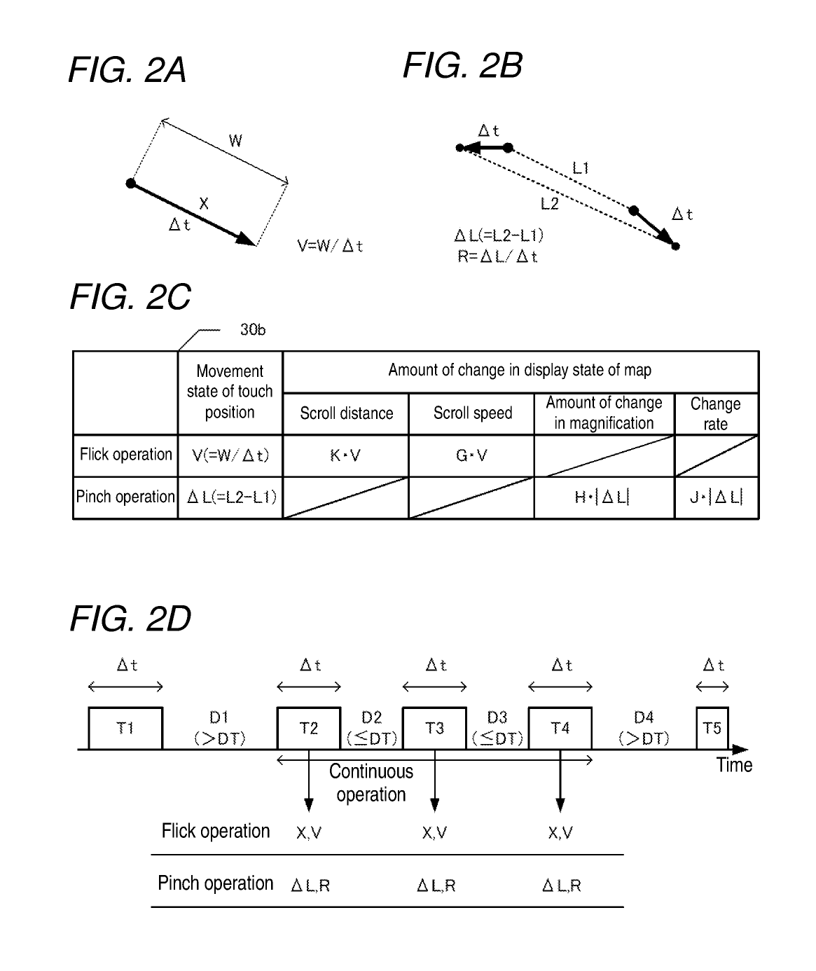

FIG. 2A is a schematic diagram of a flick operation. In the drawing, it is assumed that a touch position has moved as indicated by an arrow during a touch period with a period length Δt. The control part 20 calculates, as a moving distance W, a distance between the touch position at the beginning of the touch period (touch start position) and the touch position at the end of the touch period (touch end position), and divides the moving distance W by the period length Δt, and thereby calculates a flick speed V. Note that a vector whose start point is the touch start position and whose end point is the touch end position is represented as a flick vector X. Note also that when the flick speed V or the moving distance W is less than a reference value, the control part 20 does not accept the operation as a normal flick operation.

FIG. 2C is a table showing a correspondence between the movement states of touch positions and the amounts of change in the display state of a map. The correspondence is recorded in the correspondence information 30b. By the function of the map display module 21b, the control part 20 moves the map coordinates to end point coordinates that have proceeded a scroll distance K·V which is proportional to the flick speed V from start point coordinates which are the map coordinates of a map currently displayed, in a direction in real space corresponding to the direction of the flick vector X. By the function of the map display module 21b, the control part 20 gradually moves the map coordinates at a scroll speed G·V which is proportional to the flick speed V on a straight line connecting the start point coordinates to the end point coordinates, and ends the scrolling of the map at a point where the map coordinates have reached the end point coordinates. K and G are positive proportionality factors. The details of the proportionality factors K and G will be described later. By the function of the map display module 21b, the control part 20 renders a map every time the map coordinates change, and updates a map displayed on the touch panel display 40. The recording medium 30 that records the correspondence information 30b corresponds to a correspondence recording part of this embodiment that records a correspondence between a movement state of a touch position and the amount of change by which the display state of a map displayed on a screen is changed based on the movement state. Note, however, that the recording medium 30 serving as the correspondence recording part does not need to be provided in the in-vehicle terminal 10, and may be provided in a server, etc., that can communicate with the in-vehicle terminal 10.

In addition, by the function of the map display module 21b, the control part 20 changes the scale of the map based on the distance between two touch positions. By the function of the map display module 21b, the control part 20 obtains a distance between two touch positions for a touch period which is a period from when two fingers touch the touch panel display 40 until the fingers are released, and changes the map coordinates based on the distance. Namely, the control part 20 scrolls a map displayed on the touch panel display 40, based on a pinch operation.

FIG. 2B is a schematic diagram of a pinch operation. In the drawing, it is assumed that two touch positions have moved as indicated by arrows, respectively, during a touch period with a period length Δt. The control part 20 calculates a distance L1 between touch start positions at the beginning of the touch period and a distance L2 between touch end positions at the end of the touch period, and calculates a value obtained by subtracting the distance L1 from the distance L2, as a pinch vector ΔL. The pinch vector ΔL is a one-dimensional vector. When the distance L2 between the touch end positions is larger than the distance L1 between the touch start positions, the pinch vector ΔL is a positive vector, indicating that a so-called pinch-out operation has been performed. When the distance L2 between the touch end positions is smaller than the distance L1 between the touch start positions, the pinch vector ΔL is a negative vector, indicating that a so-called pinch-in operation has been performed.

Here, it is assumed that the magnification of a pre-scale-change (present) map with respect to the reference map with the smallest scale is Z times. When the pinch vector ΔL is positive, by the function of the map display module 21b, the control part 20 sets the magnification of a post-scale-change map to, for example, Z(1+H·|ΔL|). On the other hand, when the pinch vector ΔL is negative, by the function of the map display module 21b, the control part 20 sets the magnification of a post-scale-change map to, for example, Z(1−G·|ΔL|). H is a positive proportionality factor. Here, H·|ΔL| is a value proportional to the absolute value of the pinch vector ΔL, and indicates the amount of change in the magnification of the map for scale change. A computation expression for the magnification of the post-scale-change map may be any, and is not limited to the one exemplified as long as the magnification of the post-scale-change map depends on the magnitude of the pinch vector ΔL. Furthermore, the magnification of the post-scale-change map may depend on a pinch speed R obtained by dividing the absolute value of the pinch vector ΔL by Δt.

By the function of the map display module 21b, when the pinch vector ΔL is positive, the control part 20 repeats a process of gradually enlarging and displaying a pre-scale-change map by a pixel interpolation process until the magnification of the map reaches Z(1+H·|ΔL|). Then, when the map has been enlarged up to Z(1+H·|ΔL|), the control part 20 renders a map whose magnification is Z(1+H·|ΔL|), and displays the rendered map. On the other hand, by the function of the map display module 21b, when the pinch vector ΔL is negative, the control part 20 repeats a process of gradually reducing and displaying a pre-scale-change map by a pixel thinning-out process until the magnification of the map reaches Z(1−H·|ΔL|). Then, when the map has been reduced down to Z(1−H·|ΔL|), the control part 20 renders a map whose magnification is Z(1−H·|ΔL|), and displays the rendered map.

Upon gradually enlarging or reducing the map, the control part 20 sets the value J·|ΔL| proportional to the absolute value of the pinch vector ΔL, as a change rate. The change rate J·|ΔL| is the amount of change in the magnification of the map per unit time. J is a positive proportionality factor. The details of the proportionality factors H and J will be described later.

By a function of the correspondence revision module 21c, when the control part 20 has detected a plurality of movements of touch positions at time intervals less than or equal to a predetermined reference period, the control part 20 revises the correspondence indicated by the correspondence information 30b, based on the movement states of the touch positions for the plurality of movements. Specifically, by the function of the correspondence revision module 21c, the control part 20 revises the proportionality factor K or H in the correspondence of the correspondence information 30b (FIG. 2C), based on the movement states of the touch positions for the plurality of movements. Here, the term “the movement states of the touch positions for the plurality of movements” refers to a combination of movement states of the respective touch positions for a plurality of touch periods between which no-touch periods (time intervals) shorter than the reference period are inserted.

FIG. 2D is an illustrative diagram of the movement states of touch positions for a plurality of movements. In the drawing, a movement state is obtained during each of a plurality of touch periods T1 to T5. No-touch periods D1 to D4 during which a finger does not touch the touch panel display 40 are present between the touch periods T1 to T5. The control part 20 extracts the no-touch periods D2 and D3 whose period lengths are less than or equal to a reference period DT (e.g., one second), and obtains the movement states of touch positions for a plurality of touch periods T2 to T4 performed with the no-touch periods D2 and D3 inserted therebetween. Note, however, that the control part 20 obtains the movement states of the touch positions for the plurality of touch periods T2 to T4 during which the same type of operation has been continuously accepted, as the movement states of touch positions for a plurality of movements. For example, when a flick operation is accepted during the touch periods T2 and T4 and a pinch operation is accepted during the touch period T3, movement states therefor are not obtained as the movement states of touch positions for a plurality of movements.

When a flick operation continues, the control part 20 obtains flick vectors X for each of the touch periods T2 to T4, as the movement states of touch positions for a plurality of movements, and accumulates the flick vectors X in the continuous operation information 30c. On the other hand, when a pinch operation continues, the control part 20 obtains pinch vectors ΔL for each of the touch periods T2 to T4, as the movement states of touch positions for a plurality of movements, and accumulates the pinch vectors ΔL in the continuous operation information 30c. By the function of the correspondence revision module 21c, the control part 20 revises the proportionality factor K or H in the correspondence information 30b (FIG. 2C), based on the continuous movement states (X or ΔL) accumulated in the continuous operation information 30c.

First, revisions of the correspondence for flick operations will be described. By the function of the correspondence revision module 21c, the control part 20 revises the correspondence indicated by the correspondence information 30b such that the higher the degree of continuation of movement vectors whose directions have an analogous relationship among the movement vectors of touch positions for a plurality of movements, the larger the amount of change based on the movement state of a touch position. Specifically, by the function of the correspondence revision module 21c, the control part 20 revises the correspondence indicated by the correspondence information 30b such that the larger the absolute value of the sum of flick vectors X of touch positions for a plurality of movements, the larger the amount of change based on the movement state of a touch position.

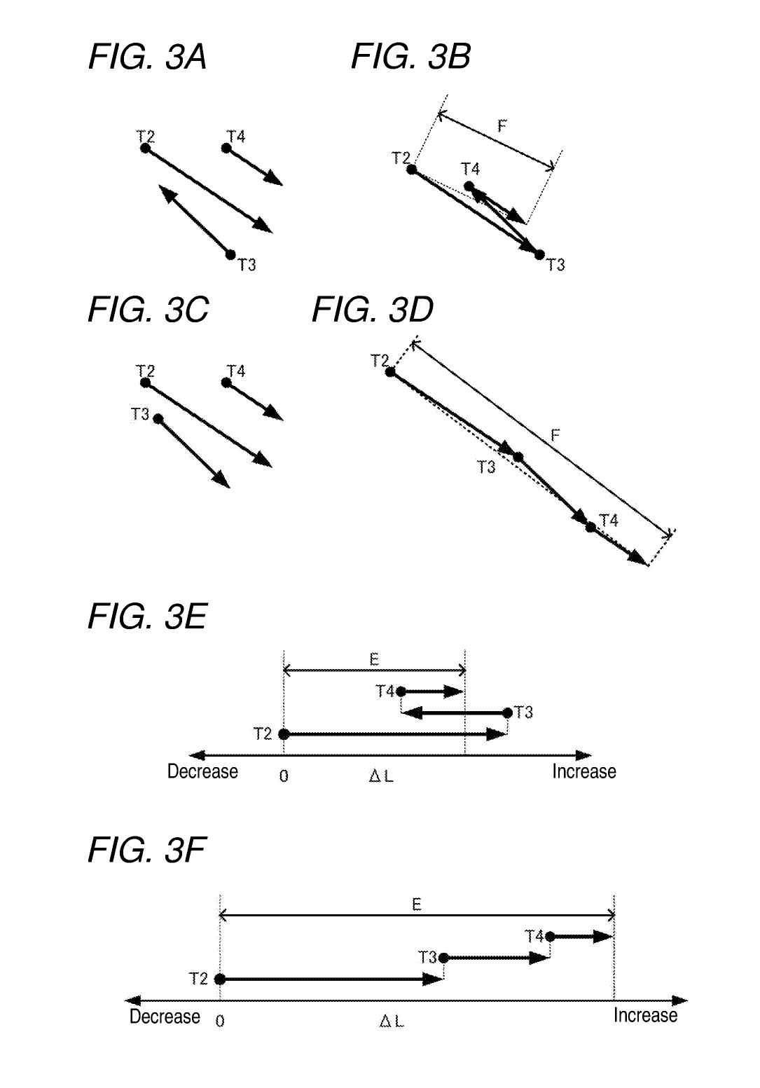

FIGS. 3A to 3D are illustrative diagrams of the absolute value of the sum of flick vectors X. FIG. 3A shows flick vectors X for the touch periods T2 to T4 during which a flick operation has been performed. In the drawing, a start point of a flick vector X indicated by a black dot is a touch start position of a flick operation, and an end point of the flick vector X indicated by an arrow's tip is a touch end position of the flick operation.

FIG. 3B is an illustrative diagram of the absolute value of the sum of the flick vectors X of FIG. 3A. As shown in the drawing, the control part 20 calculates the absolute value of the sum (combination) of the flick vectors X. FIG. 3C shows flick vectors X for the touch periods T2 to T4 during which a flick operation has been performed. FIG. 3D is an illustrative diagram of the absolute value of the sum of the flick vectors X of FIG. 3C. The control part 20 obtains the absolute value of the sum of the flick vectors X as an evaluation value F for the flick operations. Since the absolute value of the sum of the flick vectors X is calculated for each series of continuous operations, the control part 20 obtains the mean value of the absolute values of the flick vectors X as an evaluation value F for the flick operations. Note that the larger the absolute value of the sum of flick vectors X, the higher the degree of continuation of flick vectors X whose directions have an analogous relationship.

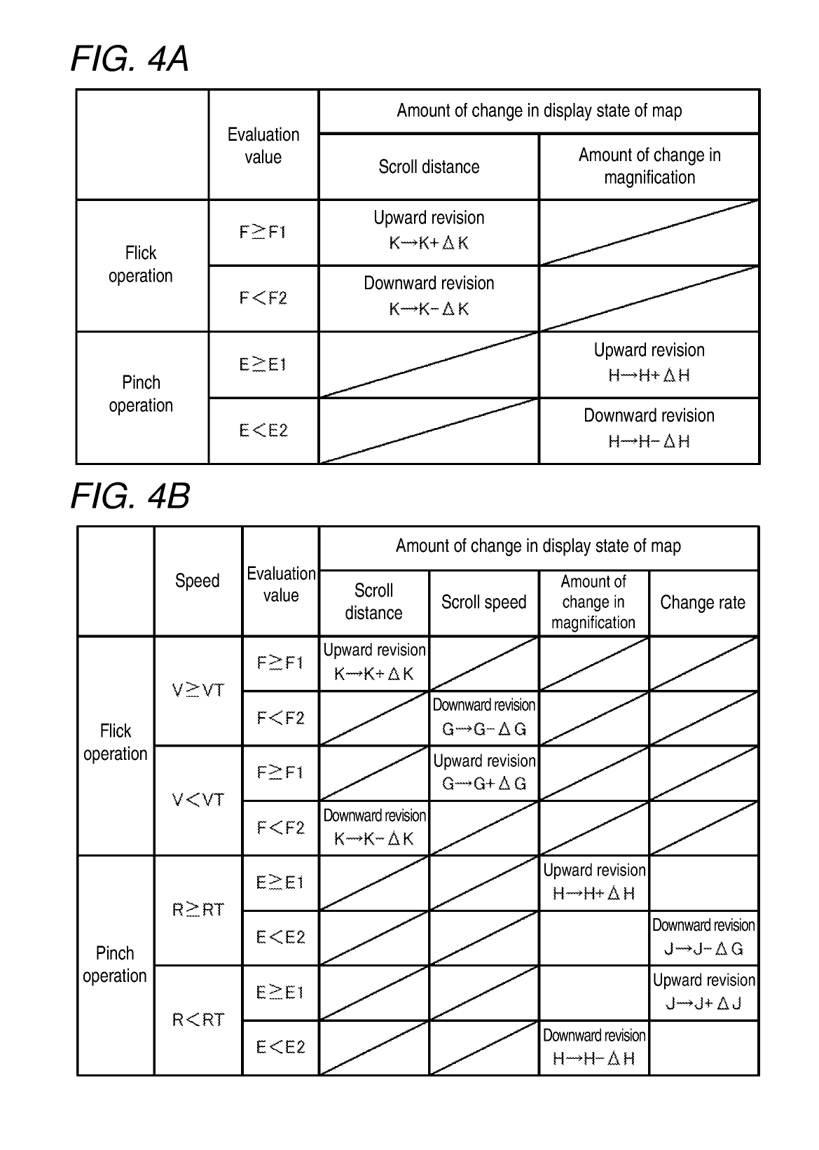

FIG. 4A is a table showing revised contents of the proportionality factors K and H. When the evaluation value F for flick operations is greater than or equal to a first threshold F1, the control part 20 revises upward the proportionality factor K by ΔK, and thereby revises upward a scroll distance which is the amount of change based on the movement state.

By the function of the correspondence revision module 21c, the control part 20 revises the correspondence indicated by the correspondence information 30b such that the higher the degree of continuation of movement vectors whose directions have an offset relationship among the movement vectors of touch positions for a plurality of movements, the smaller the amount of change based on the movement state of a touch position. Specifically, by the function of the correspondence revision module 21c, the control part 20 revises the correspondence indicated by the correspondence information 30b such that the smaller the absolute value of the sum of flick vectors X of touch positions for a plurality of movements, the smaller the amount of change based on the movement state of a touch position.

When the evaluation value F for flick operations is less than a second threshold F2, the control part 20 revises downward the proportionality factor K by ΔK, and thereby revises downward a scroll distance which is the amount of change based on the movement state. The first threshold F1 is a value greater than or equal to the second threshold F2. Note that the smaller the absolute value of the sum of flick vectors X, the higher the degree of continuation of flick vectors X whose directions have an offset relationship.

Next, revisions of the correspondence for pinch operations will be described. FIGS. 3E and 3F are illustrative diagrams of the absolute value of the sum of pinch vectors ΔL. A black dot indicates a start point of a pinch vector ΔL, and an arrow's tip is an end point of the pinch vector ΔL. As shown in the drawings, the control part 20 calculates the absolute value of the sum (combination) of pinch vectors ΔL. The control part 20 obtains the absolute value of the sum of the pinch vectors ΔL as an evaluation value E for the pinch operations. Since the absolute value of the sum of the pinch vectors ΔL is calculated for each series of continuous operations, the control part 20 obtains the mean value of the absolute values of the flick vectors X as an evaluation value F for the flick operations.

As shown in FIG. 4A, when the evaluation value E for pinch operations is greater than or equal to a first threshold E1, the control part 20 revises upward the proportionality factor H by ΔH, and thereby revises upward the amount of change in magnification H·|ΔL| which is the amount of change based on the movement state. In addition, when the evaluation value E for flick operations is less than a second threshold E2, the control part 20 revises downward the proportionality factor H by AH, and thereby revises downward the amount of change in magnification H·|ΔL| which is the amount of change based on the movement state. The first threshold E1 is a value greater than or equal to the second threshold E2. When the proportionality factors K and H are revised in the above-described manner, the control part 20 updates the correspondence information 30b (FIG. 2C) with the revised proportionality factors K and H. When the correspondence information 30b is updated, by the function of the map display module 21b, the control part 20 changes the display state of the map based on the correspondence information 30b in which the proportionality factors K and H have been revised.

In the first embodiment described above, it can be estimated, based on the movement states of touch positions for a plurality of movements, whether an operation that supplements its preceding operation has been additionally performed or whether an operation that cancels out its preceding operation has been additionally performed. When an operation that supplements its preceding operation has been additionally performed as shown in FIGS. 3C, 3D, and 3F, it is highly likely that a user feels that the display state of the map has not been changed as much as intended, based on an operation performed by him/her. In this case, the correspondence between the movement state and the amount of change is revised such that the amount of change in display state based on the movement state of a touch position is revised upward. Conversely, when an operation that cancels out its preceding operation has been additionally performed as shown in FIGS. 3A, 3B, and 3E, it is highly likely that the user feels that the display state of the map has been changed more than intended, based on an operation performed by him/her. Hence, the correspondence between the movement state and the amount of change is revised such that the amount of change in display state based on the movement state of a touch position is revised downward. As described above, a change in the display state of the map based on an operation performed on the touch device can be optimized on a user-by-user basis.

Furthermore, when the absolute value (evaluation value F or E) of the sum of movement vectors (flick vectors X or pinch vectors ΔL) for each of the touch periods T2 to T4 is large as shown in FIGS. 3C, 3D, and 3F, it can be determined that many movements have been performed in a direction in which movements performed during each of the touch periods T2 to T4 supplement each other. Namely, it can be estimated that the user feels that the amount of change (the scroll distance K·V or the amount of change in magnification H·|ΔL|) in the display state of the map is too little. Therefore, the amount of change in display state based on the movement state of a touch position is increased, by which an optimal amount of change for the user can be set.

When the absolute value (evaluation value F or E) of the sum of movement vectors (flick vectors X or pinch vectors ΔL) for each of the touch periods T2 to T4 is small as shown in FIGS. 3A, 3B, and 3E, it can be determined that many movements have been performed in a direction in which movements performed during each of the touch periods T2 to T4 cancel each other out. Namely, it can be estimated that the user feels that the amount of change in the display state of the map is too large. Therefore, the amount of change in display state based on the movement state of a touch position is reduced, by which an optimal amount of change for the user can be set.

When flick operations in analogous directions have been continuously performed as shown in FIGS. 3C and 3D, it can be estimated that the user feels that a scroll distance obtained by a flick operation is too small. That is, it can be estimated that the scroll distance is smaller than expected and thus a flick operation has been performed again and again in the same direction. In such a case, the scroll distance based on a flick operation is revised upward. On the other hand, when flick operations have been continuously performed in directions that are nearly opposite directions as shown in FIGS. 3A and 3B, it can be estimated that the user feels that a scroll distance obtained by a flick operation is too large. That is, it can be estimated that the scroll distance is larger than expected and thus a flick operation that scrolls the map in an opposite direction has been performed again and again. In such a case, the scroll distance based on a flick operation is revised downward. As such, the amount of change (scroll distance) in the location of the map based on the moving speed of a touch position in a so-called flick operation can be optimized on a user-by-user basis.

When a pinch-out operation has been continuously performed as shown in FIG. 3F, it can be estimated that the user feels that the amount of change in magnification obtained by a pinch operation is too small. In such a case, the amount of change in magnification H·|ΔL| based on a pinch operation is revised upward. That is, it can be estimated that the amount of change in magnification is smaller than expected and thus a pinch-out operation has been performed again and again. Though not shown, the same also applies to a case in which a pinch-in operation has been continuously performed. When a pinch-in operation and a pinch-out operation have been continuously performed as shown in FIG. 3E, it can be estimated that the user feels that the amount of change in magnification obtained by a pinch operation is too large. That is, it can be estimated that the amount of change in magnification is larger than expected and thus both a pinch-out operation and a pinch-in operation have been performed again and again. In such a case, the amount of change in magnification H·|ΔL| based on a pinch operation is revised downward. As such, the amount of change in the scale of the map based on the distance between two touch positions in a so-called pinch operation can be optimized on a user-by-user basis.

(2) Correspondence Revision Process

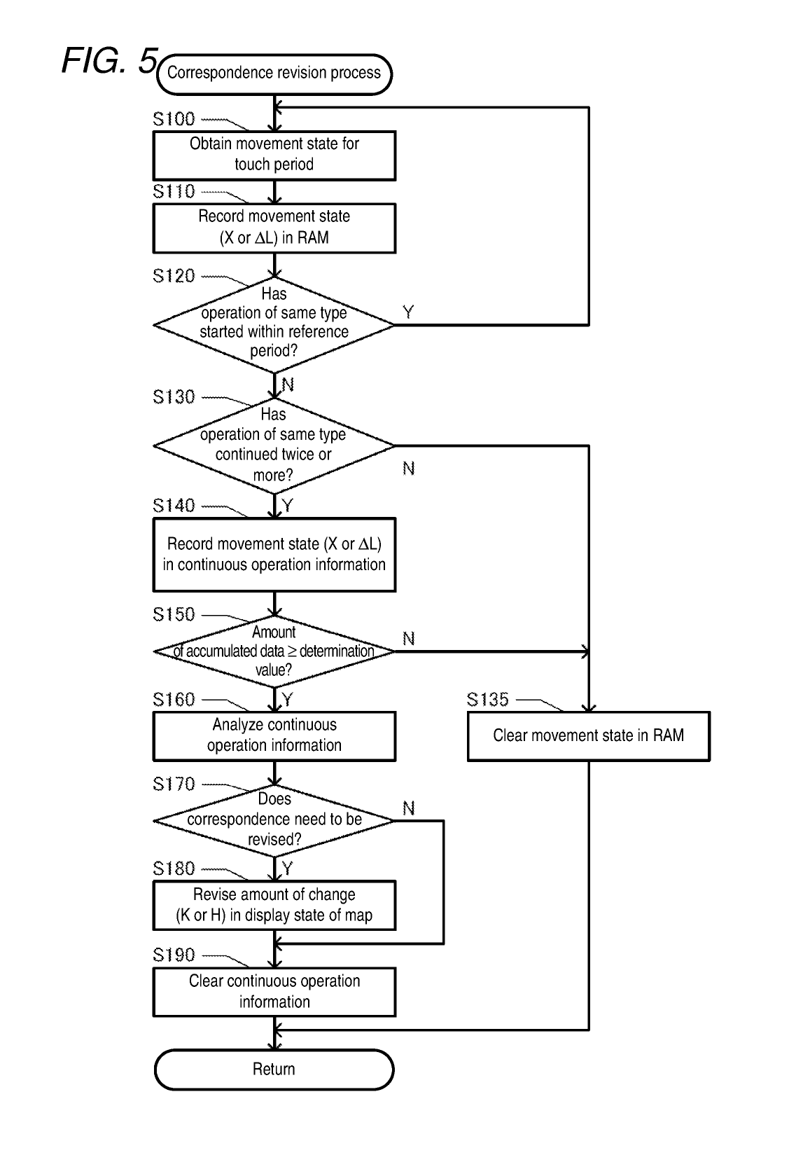

FIG. 5 is a flowchart of a correspondence revision process. The correspondence revision process is a process that is performed at all times during a period during which a map is displayed on the touch panel display 40. First, by the function of the map display module 21b, the control part 20 obtains a movement state of a touch position for a touch period (step S110). Namely, the control part 20 obtains a movement state of one or two finger touch positions for a period from when a finger(s) starts to touch the touch panel display 40 until the touch ends.

Then, by the function of the correspondence revision module 21c, the control part 20 records the movement state in the RAM (step S110). Namely, when the finger touch ends, the control part 20 records a flick vector X or a pinch vector ΔL in the RAM, as the movement state for the touch period. Specifically, when a flick operation has been accepted during the touch period, the control part 20 records a flick vector X in the RAM. On the other hand, when a pinch operation has been accepted during the touch period, the control part 20 records a pinch vector ΔL in the RAM.

Then, by the function of the correspondence revision module 21c, the control part 20 determines whether a next operation of the same type has started within a reference period DT (step S120). Namely, the control part 20 determines whether a next touch period has started before a lapse of the reference period DT which starts from an end time of the last touch time, and an operation of the same type as that for the last touch period has been accepted during the next touch period. The expression “an operation of the same type has been accepted” refers to that either one of a flick operation and a pinch operation has been continuously accepted.

If it is determined that an operation of the same type has started within a reference period DT (step S120: Y), by the function of the correspondence revision module 21c, the control part 20 returns to step S100, and obtains a movement state of a touch position for the next touch period. Namely, the movement state of the operation of the same type is continuously obtained and the continuously obtained movement state is recorded in the RAM.

On the other hand, if it is not determined that an operation of the same type has started within a reference period DT (step S120: N), by the function of the correspondence revision module 21c, the control part 20 determines whether an operation of the same type has continued twice or more (step S130). Namely, the control part 20 determines whether two or more flick vectors X or two or more pinch vectors ΔL have been continuously recorded in the RAM at step S110.

If it is not determined that an operation of the same type has continued twice or more (step S130: N), by the function of the correspondence revision module 21c, the control part 20 clears the movement state in the RAM (step S135) and returns to the beginning of the correspondence revision process. On the other hand, if it is determined that an operation of the same type has continued twice or more (step S130: Y), by the function of the correspondence revision module 21c, the control part 20 records the movement states in the continuous operation information 30c (step S140). Namely, the two or more flick vectors X or two or more pinch vectors ΔL recorded in the RAM are accumulated in the continuous operation information 30c, as one set of movement states.

Next, by the function of the correspondence revision module 21c, the control part 20 determines whether the amount of accumulated data is greater than or equal to a determination value (step S150). Namely, when two or more flick vectors X are recorded at step S140, the control part 20 determines whether the number of sets of continuous flick vectors X recorded in the continuous operation information 30c has reached greater than or equal to the determination value. In addition, when two or more pinch vectors ΔL are recorded at step S140, the control part 20 determines whether the number of sets of continuous pinch vectors ΔL recorded in the continuous operation information 30c has reached greater than or equal to the determination value. The determination value is a predetermined number and may be, for example, 20 sets.

If it is not determined that the amount of accumulated data is greater than or equal to a determination value (step S150: N), by the function of the correspondence revision module 21c, the control part 20 clears the movement states in the RAM (step S135) and returns to the beginning of the correspondence revision process. Namely, until the amount of accumulated data of flick vectors X or pinch vectors ΔL has reached greater than or equal to the determination value, a process of accumulating those data in the continuous operation information 30c is repeated.

If it is determined that the amount of accumulated data is greater than or equal to a determination value (step S150: Y), by the function of the correspondence revision module 21c, the control part 20 analyzes the continuous operation information (step S160). Specifically, when the amount of accumulated data of flick vectors X has reached greater than or equal to the determination value, as shown in FIGS. 3A to 3D, the control part 20 calculates, for each set of continuous flick vectors X, the absolute value of the sum of the flick vectors X, and calculates the mean value of the absolute values as an evaluation value F for the flick operations. In addition, when the amount of accumulated data of pinch vectors ΔL has reached greater than or equal to the determination value, as shown in FIGS. 3E and 3F, the control part 20 calculates, for each set of continuous pinch vectors ΔL, the absolute value of the sum of the pinch vectors ΔL, and calculates the mean value of the absolute values as an evaluation value E for the pinch operations.

Then, by the function of the correspondence revision module 21c, the control part 20 determines whether the correspondence needs to be revised (step S170). Specifically, in a case in which an evaluation value F for flick operations is calculated, when the evaluation value F corresponds to a value greater than or equal to the first threshold F1 or less than the second threshold F2, the control part 20 determines that the correspondence needs to be revised. In addition, in a case in which an evaluation value E for pinch operations is calculated, when the evaluation value E corresponds to a value greater than or equal to the first threshold E1 or less than the second threshold E2, the control part 20 determines that the correspondence needs to be revised.

If it is determined that the correspondence needs to be revised (step S170: Y), by the function of the correspondence revision module 21c, the control part 20 revises the amount of change in the display state of a map (step S180). Namely, as shown in FIG. 4A, when the evaluation value F for flick operations is greater than or equal to the first threshold F1, the control part 20 revises upward the proportionality factor K of the scroll distance by ΔK, and when the evaluation value F for flick operations is less than the second threshold F2, the control part 20 revises downward the proportionality factor K of the scroll distance by ΔK. In addition, when the evaluation value E for pinch operations is greater than or equal to the first threshold E1, the control part 20 revises upward the proportionality factor H of the amount of change in magnification H·|ΔL| by ΔH, and when the evaluation value E for pinch operations is less than the second threshold E2, the control part 20 revises downward the proportionality factor H of the amount of change in magnification H·|ΔL| by ΔH.

Then, by the function of the correspondence revision module 21c, the control part 20 clears the continuous operation information 30c (step S190) and ends the correspondence revision process. On the other hand, if it is not determined that the correspondence needs to be revised (step S170: N), by the function of the correspondence revision module 21c, the control part 20 clears the continuous operation information 30c (step S190) without revising the proportionality factor K or H, and ends the correspondence revision process.

(3) Other Embodiments

The above-described embodiment is an example for carrying out certain aspect, and various other embodiments can also be adopted. Although, in the above-described embodiment, the scroll distance K·V and the amount of change in magnification H·|ΔL| for scrolling of a map and for scale change are revised, the scroll speed G·V and the change rate J·|ΔL| of the magnification of a map may also be revised.

FIG. 4B is a table showing revised contents of the proportionality factors K, G, H, and J. When, even if the evaluation value F for flick operations is greater than or equal to the first threshold F1, the mean value of flick speeds V is less than a speed threshold VT, the control part 20 revises upward the proportionality factor G instead of the proportionality factor K, and thereby revises upward the scroll speed G·V which is the amount of change based on the movement state. In this case, it is estimated that the user feels that the scroll speed G·V is not fast enough. When, even if the evaluation value F for flick operations is less than the second threshold F2, the mean value of flick speeds V is greater than or equal to the speed threshold VT, the control part 20 revises downward the proportionality factor G instead of the proportionality factor K, and thereby revises downward the scroll speed G·V which is the amount of change based on the movement state. In this case, it is estimated that the user is repeating a flick operation in an opposite direction because the scroll speed G·V is too fast.

When, even if the evaluation value E for pinch operations is greater than or equal to the first threshold E1, the mean value of pinch speeds R is less than a speed threshold RT, the control part 20 revises upward the proportionality factor J instead of the proportionality factor H, and thereby revises upward the change rate J·|ΔL| of the magnification of a map which is the amount of change based on the movement state. In this case, it is estimated that the user feels that the change rate J·|ΔL| of the magnification of a map is not fast enough. Note that the pinch speed R is a value obtained by dividing a pinch vector ΔL by the length Δt of a touch period. When, even if the evaluation value E for pinch operations is less than the second threshold E2, the mean value of pinch speeds R is greater than or equal to the speed threshold RT, the control part 20 revises downward the proportionality factor J instead of the proportionality factor H, and thereby revises downward the change rate J·|ΔL| of the magnification of a map which is the amount of change based on the movement state. In this case, it is estimated that the user is repeating a pinch operation in an opposite direction because the change rate J·|ΔL| of the magnification of a map is too fast.

Note that the control part 20 may simultaneously revise both the scroll distance K·V and the scroll speed G·V instead of only either one of the scroll distance K·V and the scroll speed G·V. Furthermore, the control part 20 may simultaneously revise both the amount of change in magnification H·|ΔL| and the change rate J·|ΔL| of the magnification of a map instead of only either one of them. In addition, the control part 20 may use only either one of a flick operation and a pinch operation as a revision target.

In addition, the degree of continuation of movement vectors whose directions have an analogous relationship or an offset relationship does not necessarily need to be determined based on the absolute value of the sum of the movement vectors. Specifically, when a difference in direction between an Nth flick vector X (N is an integer indicating the order of operation) and an N+1th flick vector X is less than or equal to a first threshold (e.g., 10 degrees), the control part 20 may determine that the directions of the Nth and N+1th flick vectors X have an analogous relationship. Furthermore, when a difference in direction between the Nth flick vector X and the N+1th flick vector X is from 180 degrees to a second threshold (e.g., 10 degrees), the control part 20 may determine that the directions of the Nth and N+1th flick vectors X have an offset relationship. The control part 20 may determine the above-described determination for all sets of continuous flick vectors X, and make a revision such that the larger the number of sets of flick vectors X whose directions have an analogous relationship, the larger the upward revision made to the proportionality factor K of the scroll distance. On the other hand, the control part 20 may make a revision such that the larger the number of sets of flick vectors X whose directions have an offset relationship, the larger the downward revision made to the proportionality factor K of the scroll distance.

In addition, when the number of sets of flick vectors X or sets of pinch vectors ΔL accumulated in the continuous operation information 30c has reached greater than or equal to the determination value (e.g., 20), the control part 20 revises the proportionality factor K or H by ΔK or ΔH, but ΔK and ΔH do not need to be fixed. For example, the control part 20 may increase the value of ΔK or ΔAH as the number of times an upward revision has been continuously made increases. Likewise, the control part 20 may increase the value of ΔK or ΔH as the number of times a downward revision has been continuously made increases. Furthermore, the control part 20 may reduce the value of ΔK or ΔH as the number of times an upward revision and a downward revision have been alternately made increases. In addition, the determination value does not need to be 20, and may be any value greater than or equal to 1. When the determination value is small, it increases the possibility of doing too much revision of the proportionality factors K and H, and thus, the control part 20 may reduce the magnitude of ΔK and ΔH as the determination value decreases.

The touch device may be any device as long as it detects at least a touch position of an operating object, and may be a touch panel display that detects a touch position of an operating object on a display surface. Furthermore, the touch panel display may be a touch panel display that displays a map, or may be a touch panel display that does not display a map. The operating object may be a user's finger or may be a touch pen, etc.

The movement state of a touch position may be the amount of change (moving distance) in the touch position, or may be the amount of change (moving speed) in the touch position per unit time. The map display part obtains an amount of change corresponding to a movement state of a touch position, and changes the display state of a map by the amount of change. The amount of change in the display state of the map may be the amount of change (scroll distance) in the location of the map, or may be the amount of change (scroll speed) in the location of the map per unit time, or may be the amount of change (enlargement ratio/reduction ratio) in the scale of the map, or may be the amount of change (change rate/reduction rate) in the scale of the map per unit time. In addition, the movement state of a touch position and the display state of a map may be a state in a straight-line direction on the touch panel display, or may be a state in a rotational direction. Furthermore, the number of touch positions to be detected is not limited to one, and two or more touch positions may be detected. When two or more touch positions are detected, a state of a relative positional relationship between the two or more touch positions may be obtained as the movement state of a touch position.

The correspondence revising part revises a correspondence between the movement state of a touch position and the amount of change in the display state of a map, based on the movement states of touch positions for a plurality of movements. Specifically, when it can be determined, based on the movement states of touch positions for a plurality of movements, that the amount of change in the display state of the map is too large, the correspondence revising part may revise downward the amount of change in the display state of the map. On the other hand, when it can be determined, based on the movement states of touch positions for a plurality of movements, that the amount of change in the display state of the map is too small, the correspondence revising part may revise upward the amount of change in the display state of the map. The term “the movement states of touch positions for a plurality of movements” refers to a combination of movement states of the respective touch positions for a plurality of touch periods between which no-touch periods shorter than the reference period are inserted.

In addition, the correspondence revising part may revise the correspondence such that the larger the absolute value of the sum of movement vectors of touch positions for a plurality of movements, the larger the amount of change based on the movement state of a touch position. When the absolute value of the sum of movement vectors for each touch period is large, it can be determined that many movements have been performed in a direction in which movements performed during each touch period supplement each other. Namely, it can be estimated that the user feels that the amount of change in the display state of the map is too small. Therefore, the amount of change in display state based on the movement state of a touch position is increased, by which an optimal amount of change for the user can be set. In addition, the movement vector may be a movement vector of a touch position on the touch device itself, or may be a change vector (one-dimensional decrease/increase vector) of a distance between two touch positions on the touch device.

Furthermore, the correspondence revising part may revise the correspondence such that the smaller the absolute value of the sum of movement vectors of touch positions for a plurality of movements, the smaller the amount of change based on the movement state of a touch position. When the absolute value of the sum of movement vectors for each touch period is small, it can be determined that many movements have been performed in a direction in which movements performed during each touch period cancel each other out. Namely, it can be estimated that the user feels that the amount of change in the display state of the map is too large. Therefore, the amount of change in display state based on the movement state of a touch position is reduced, by which an optimal amount of change for the user can be set.

Note that the display state may be the location of a map. By this, the amount of change in the location of the map based on the moving speed of a touch position can be optimized on a user-by-user basis. Specifically, the map display part may change the location of the map based on the moving speed of a touch position in a so-called flick operation. By this, the amount of change in the location of the map based on the moving speed of a touch position in a flick operation can be optimized on a user-by-user basis.

Furthermore, the display state may be the scale of a map. By this, the amount of change in the scale of the map based on the movement state of a touch position can be optimized on a user-by-user basis. Specifically, the map display part may change the scale of the map based on the distance between two touch positions in a so-called pinch operation. By this, the amount of change in the scale of the map based on the distance between two touch positions in a pinch operation can be optimized on a user-by-user basis.

Furthermore, a technique for accepting an operation based on the movement of a touch position as in the above described embodiments can also be applied as a program or a method. In addition, a case in which a system, a program, and a method such as those described above are implemented as a single apparatus and a case in which such a system, a program, and a method are implemented by a plurality of apparatuses can be assumed, and various modes are included. For example, it is possible to provide a navigation system, a terminal, a method, or a program that has a configuration such as that described above. In addition, changes can be made as appropriate, such as some are software and some are hardware. Furthermore, the embodiments may also be realized as a recording medium for a program that controls the system. Of course, the recording medium for software may be a magnetic recording medium or a semiconductor memory, or even any recording medium to be developed in the future can also be considered exactly in the same manner.

### REFERENCE SIGNS LIST

10: In-vehicle terminal, 20: Control part, 21: Map display program, 21a: Touch position detection module, 21b: Map display module, 21c: Correspondence revision module, 30: Recording medium, 30a: Map information, 30b: Correspondence information, 30c: Continuous operation information, 40: Touch panel display, E: Evaluation value for pinch operations, F: Evaluation value for flick operations, R: Pinch speed, RT: Speed threshold, V: Flick speed, W: Moving distance, X: Flick vector, and _ΔL: Pinch vector

1. A map display system comprising:
a touch position detecting part that detects a touch position of an operating object on a touch device;
a correspondence recording part that records a correspondence between a movement state of the touch position and an amount of change by which a display state of a map displayed on a screen is changed based on the movement state;
a map display part that changes a display state of the map by the amount of change based on the movement state of the touch position; and
a correspondence revising part that revises, when a plurality of movements of the touch positions have been detected at time intervals, the correspondence based on the movement states of the touch positions for the plurality of movements, the time intervals being less than or equal to a predetermined reference period,
wherein
the map display part changes a display state of the map based on the revised correspondence.

2. The map display system according to claim 1, wherein the correspondence revising part revises the correspondence such that higher a degree of continuation of movement vectors whose directions have an analogous relationship among movement vectors of the touch positions for the plurality of movements, larger the amount of change based on the movement state of the touch position.

3. The map display system according to claim 2, wherein the correspondence revising part revises the correspondence such that larger an absolute value of a sum of movement vectors of the touch positions for the plurality of movements, larger the amount of change based on the movement state of the touch position.

4. The map display system according to claim 1, wherein the correspondence revising part revises the correspondence such that higher a degree of continuation of movement vectors whose directions have an offset relationship among movement vectors of the touch positions for the plurality of movements, smaller the amount of change based on the movement state of the touch position.

5. The map display system according to claim 1, wherein the correspondence revising part revises the correspondence such that smaller an absolute value of a sum of movement vectors of the touch positions for the plurality of movements, smaller the amount of change based on the movement state of the touch position.

6. The map display system according to claim 1, wherein the display state is a location of the map.

7. The map display system according to claim 6, wherein the map display part changes a location of the map based on a moving speed of the touch position in a flick operation.

8. The map display system according to claim 1, wherein the display state is a scale of the map.

9. The map display system according to claim 8, wherein the map display part changes a scale of the map based on a distance between the two touch positions in a pinch operation or based on a sum of magnitudes of movement vectors of the touch positions.

10. A map display program stored on a non-transitory computer readable medium causing a computer to function as:
a touch position detecting part that detects a touch position of an operating object on a touch device;
a correspondence recording part that records a correspondence between a movement state of the touch position and an amount of change by which a display state of a map displayed on a screen is changed based on the movement state;
a map display part that changes a display state of the map by the amount of change based on the movement state of the touch position; and
a correspondence revising part that revises, when a plurality of movements of the touch positions have been detected at time intervals, the correspondence based on the movement states of the touch positions for the plurality of movements, the time intervals being less than or equal to a predetermined reference period,
wherein the map display part changes a display state of the map based on the revised correspondence.
